(19) United States
(12) Patent Application Publication
(10) Pub. No.: US 2026/0019947 A1
(43) Pub. Date: Jan. 15, 2026

(54) METHODS, ARCHITECTURES, APPARATUSES AND SYSTEMS FOR WAVEFORM GENERATION OF WAKE-UP RADIO (WUR) SIGNALS

(71) Applicant: InterDigital Patent Holdings, Inc., Wilmington, DE (US)

(72) Inventors: Ying Wang, Easton, PA (US); Rui Yang, Greenlawn, NY (US); Hanqing Lou, Syosset, NY (US); Mahmoud Saad, L'lle Bizard (CA)

(21) Appl. No.: 18/771,500

(22) Filed: Jul. 12, 2024

(51) Int. Cl. H04W 52/02; H04L 5/00

(52) U.S. Cl. CPC H04W 52/0229; H04L 5/0007

(57) ABSTRACT

Procedures, methods, architectures, apparatuses, systems, devices, and computer program products related to waveform generation of wake-up radio (WUR) signals. One method may include receiving, from an access point (AP), a physical protocol data unit (PPDU) including a wake up radio (WUR) portion and a non-WUR portion. The WUR portion includes a WUR signal occupying a first plurality of resource units (RUs). The WUR signal includes orthogonal frequency division multiplexing (OFDM) modulated information and on-off-keying (OOK) modulated information. The non-WUR portion includes OFDM signals occupying a second plurality of resource units (RUs). The WUR signal may use a same guard interval and OFDM symbol duration as the OFDM signals. The WUR signal and OFDM signals may be orthogonal to each other in a frequency domain. The method may further include demodulating one of the OFDM modulated information and/or the OOK modulated information included in the WUR signal.

### FIELD

Example embodiments described in the present disclosure are generally directed to the fields of communications, software and/or encoding, including, for example, to methods, architectures, apparatuses, systems related to waveform generation of wake-up radio (WUR) signals.

### BACKGROUND

Low power devices may be used in a number of applications and Internet-of-Things (IoT) use cases. For example, such use cases may include healthcare, smart home, industrial sensors, wearables, etc. Devices used in these applications are usually powered by a battery. Prolonging the battery lifetime while also maintaining low latency becomes an important objective. Hence, it is desirable for power efficient mechanisms be used with battery-operated devices while maintaining low latency where it is required. For instance, a typical frequency domain multiple access (FDMA) active receiver may consume tens to hundreds of milliwatts. To further reduce power consumption, devices can use power save modes. Devices based on the IEEE 802.11 power save modes periodically wake up from a sleep state to receive information from an access point (AP) and to know if there are data to receive from the AP. The longer the devices stay in the sleep state, the lower power the devices consume but at the expense of increased latency of data reception.

### SUMMARY

Some embodiments may be directed to a station (STA) including a transceiver and a processor coupled to the transceiver. The transceiver and processor are configured to receive, from an access point (AP), a physical protocol data unit (PPDU) including a wake up radio (WUR) portion and a non-WUR portion. The WUR portion includes a WUR signal occupying a first plurality of resource units (RUs). The WUR signal includes orthogonal frequency division multiplexing (OFDM) modulated information and on-off-keying (OOK) modulated information. The non-WUR portion includes OFDM signals occupying a second plurality of resource units (RUS). The WUR signal uses a same guard interval and OFDM symbol duration as the OFDM signals. The WUR signal and OFDM signals are orthogonal to each other in the frequency domain. The transceiver and processor are configured to demodulate any of the OFDM modulated information and/or the OOK modulated information included in the WUR signal.

Some embodiments may be directed to a method including receiving, from an access point (AP), a physical protocol data unit (PPDU) including a wake up radio (WUR) portion and a non-WUR portion. The WUR portion may include a WUR signal occupying a first plurality of resource units (RUs). The WUR signal may include orthogonal frequency division multiplexing (OFDM) modulated information and on-off-keying (OOK) modulated information. The non-WUR portion may include OFDM signals occupying a second plurality of resource units (RUs). The WUR signal uses a same guard interval and OFDM symbol duration as the OFDM signals. The WUR signal and OFDM signals are orthogonal to each other in the frequency domain. The method may include demodulating any of the OFDM modulated information and/or the OOK modulated information included in the WUR signal.

Some embodiments may be directed to an access point (AP) including a transceiver and a processor coupled to the transceiver. The transceiver and processor are configured to transmit, to a station (STA), a physical protocol data unit (PPDU) including a wake up radio (WUR) portion and a non-WUR portion. The WUR portion includes a WUR signal occupying a first plurality of resource units (RUs). The non-WUR portion includes orthogonal frequency division multiplexing (OFDM) signals occupying a second plurality of resource units (RUs). The WUR signal uses a same guard interval and OFDM symbol duration as the OFDM signals. The WUR signal and OFDM signals are orthogonal to each other. The transceiver and processor are configured to modulate the first plurality of RUs of the WUR portion and the second plurality of RUs of the non-WUR portion by a single orthogonal multicarrier transmitter. The modulated first plurality of RUs include OFDM modulated information and on-off-keying (OOK) modulated information.

Some embodiments may be directed to a method including transmitting, to a station (STA), a physical protocol data unit (PPDU) including a wake up radio (WUR) portion and a non-WUR portion. The WUR portion may include a WUR signal occupying a first plurality of resource units (RUs), and the non-WUR portion may include orthogonal frequency division multiplexing (OFDM) signals occupying a second plurality of resource units (RUs). The WUR signal may use the same guard interval and OFDM symbol duration as the OFDM signals. The WUR signal and OFDM signals are orthogonal to each other. The method may include modulating the first plurality of RUs of the WUR portion and the second plurality of RUs of the non-WUR portion by a single orthogonal multicarrier transmitter. The modulated first plurality of RUs include OFDM modulated information and on-off-keying (OOK) modulated information.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a system diagram, according to some embodiments;

FIG. 3 illustrates an example WUR PPDU format, according to some embodiments;

FIG. 4 illustrates an example of a WUR FDMA PPDU for 80 MHz channel widths, according to some embodiments;

FIG. 5 illustrates an example of aggregating a WUR PPDU with UHR PPDU, according to some embodiments;

FIG. 6 illustrates an example RU allocation, according to some embodiments;

FIG. 7 illustrates a transmit spectrum mask for WUR-Sync and WUR-Data fields of WUR basic PPDU transmission, according to some embodiments;

FIG. 8 illustrates an example of a WUR signal aggregated with other OFDM signals using one IFFT operation, according to some embodiments;

FIG. 9 illustrates an example of a WUR signal aggregated with other OFDM signals and zero-valued RUs as guard band, according to some embodiments;

FIG. 10A illustrates a flow diagram of a method, according to some embodiments; and

FIG. 10B illustrates a flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

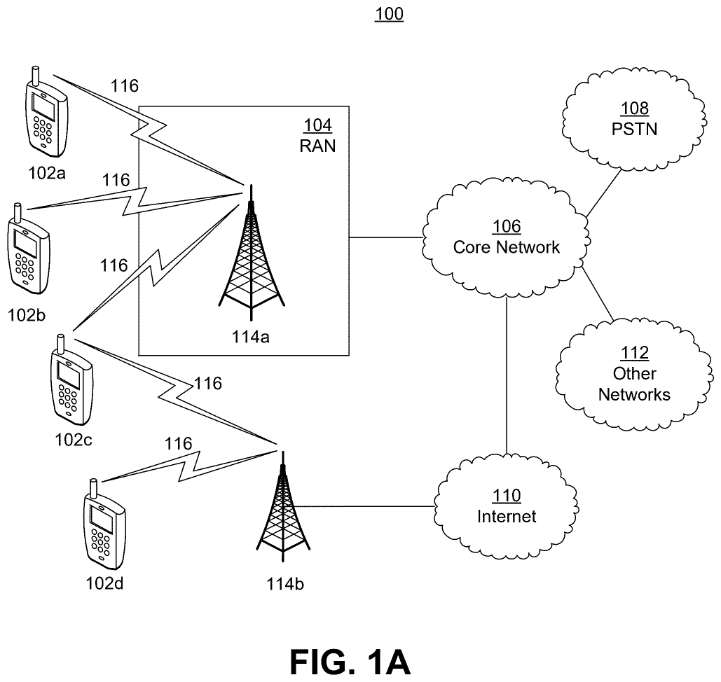

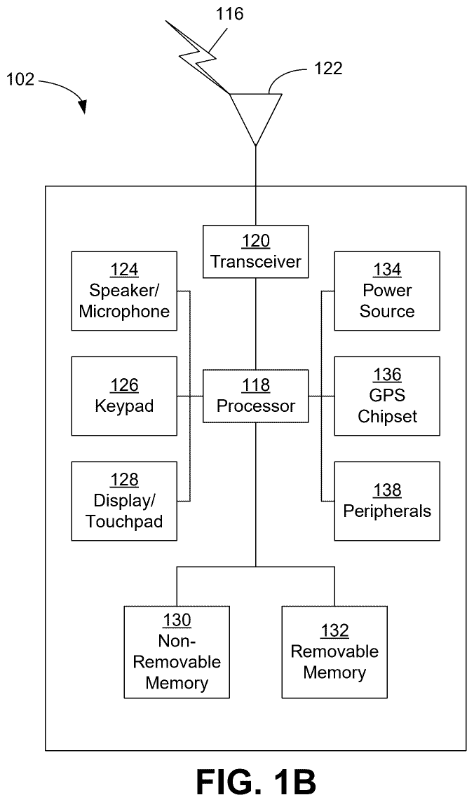

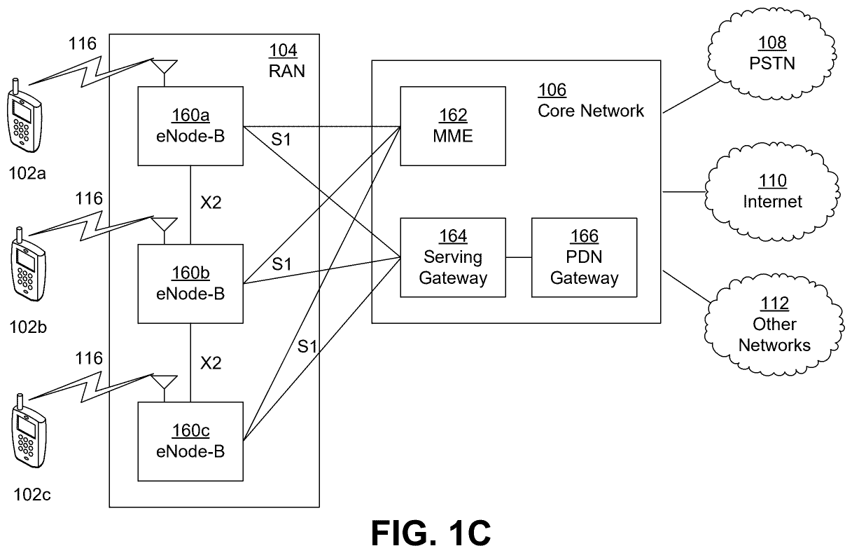

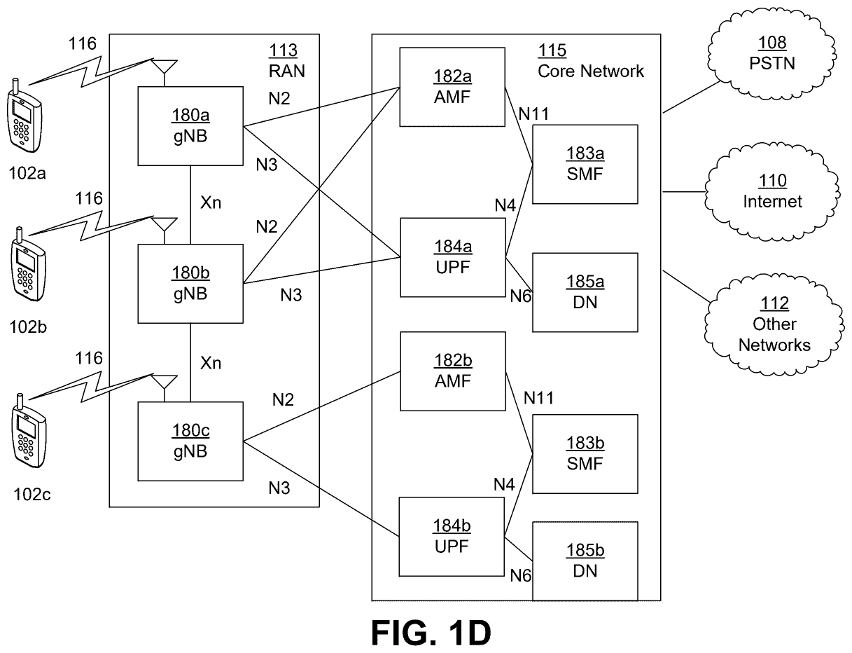

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements or peripherals 138, which may include one or more software and/or hardware modules or units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor, and the like.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in some embodiments that such a terminal may use (e.g., temporarily or permanently) wired communication interfaces with the communication network.

In some embodiments, the other network 112 may be a WLAN.

A WLAN in Infrastructure Basic Service Set (BSS) mode may have an Access Point (AP) for the BSS and one or more stations (STAs) associated with the AP (e.g., See IEEE Std 802.11™-2020: Wireless LAN Medium Access Control (MAC) and Physical Layer (PHY) Specifications [1]). The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In some embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In some embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In some embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHZ, and/or 160 MHz wide channels transmitted over a 5 GHz frequency band using OFDMA (e.g., See IEEE P802.11ax™/D8.0: Wireless LAN Medium Access Control (MAC) and Physical Layer (PHY) Specifications [2]). The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

Sub 1 GHz modes of operation are supported by 802.11af and 802.11ah (e.g., See IEEE P802.11-REVme™/D5.0, Wireless LAN Medium Access Control (MAC) and Physical Layer (PHY) Specifications, February 2024 [3]). For these specifications the channel operating bandwidths, and the number of OFDM subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHZ, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel may therefore be limited by the STA that supports the smallest bandwidth operating mode in the BSS. In the example of 802.11ah, the primary channel may be 1 MHz wide if there are STAs (e.g., MTC type devices) that only support a 1 MHz mode even if the AP, and other STAs in the BSS, may support 2 MHz, 4 MHZ, 8 MHz, 16 MHz, or other channel bandwidth operating modes. The carrier sensing and NAV settings depend on the status of the primary channel, i.e., if the primary channel is busy, for example, due to a STA supporting only a 1 MHz operating mode is transmitting to the AP, then the entire available frequency bands may be considered busy even though majority of it stays idle and available.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “serving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

Low power devices manifest themselves in a number of applications and/or Internet-of-Things (IoT) usage cases. These use cases may include healthcare, smart home, industrial sensors, wearables, etc. Devices used in these applications are usually powered by a battery. Prolonging the battery lifetime while in some use cases also maintaining low latency is desirable. Power efficient mechanisms need to be used with battery-operated devices while maintaining low latency where it is required. A typical OFDM active receiver consumes tens to hundreds of milliwatts. To further reduce power consumption, devices use power save modes. Devices based on the IEEE 802.11 power save modes periodically wake up from a sleep state to receive information from an access point (AP) and to know if there are data to receive from the AP. The longer the devices stay in the sleep state, the lower power the devices consume but at the expense of increased latency of data reception. Given the limitation of the above power saving methods, 802.11ba was developed to enable more significant power saving while supporting low-latency traffic.

As specified in the 802.11ba project authorization request (PAR) document (e.g., See IEEE 802.11-16/1045r9, “A PAR Proposal for Wake-up Radio,” July 2016 [4]), 802.11ba defines a physical layer specification and medium access control layer specification that enables operation of a wake-up radio (WUR) for 802.11 devices. The 802.11ba WUR is a companion radio to the primary connectivity radio or the main radio (MR) that supports 802.11 standards such as non-HT, HT, VHT, or HE. The main radio would stay in deep sleep mode most of the time and only turn on to transfer data when the WUR receives a wake-up message. This leads to ultra-low power consumption while supporting low-latency traffic. To serve this purpose, some requirements that are to be satisfied may include: the wake-up frames carry only control information that can trigger a transition of the primary connectivity radio out of sleep; the WUR meets the same range requirement as the primary connectivity radio; the WUR devices coexist with legacy IEEE 802.11 devices in the same band; and/or the WUR has an expected active receiver power consumption of less than one milliwatt.

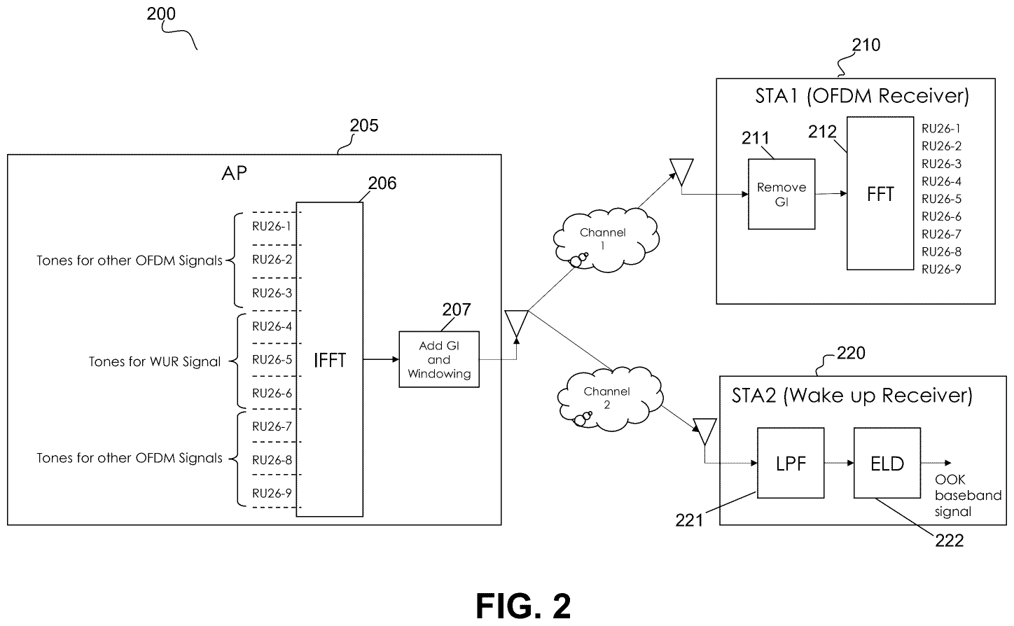

FIG. 2 illustrates an example diagram of a system 200, according to some embodiments. As illustrated in the example of FIG. 2, the system 200 may include an AP 205, STA1 210, and STA2 220. STA1 210 may include a block 211 to remove the guard interval (e.g., circuitry configured to remove the GI) and a fast Fourier Transform (FFT) block 212. STA2 220 may include a WUR receiver including a low pass filter (LPF) 221 and envelope detector (ELD) 222. The AP 205 may include an inverse fast Fourier Transform (IFFT) block 206 that can modulate resource units (RUs). For instance, in the example of FIG. 2, the three center 26-tone RUs may be modulated by IFFT block 206 to construct a WUR signal (e.g., intended for a WUR receiver at a STA) and other RUs may be modulated by IFFT block 206 to construct OFDMA signals (e.g., intended for OFDM or non-WUR receivers at other STAs). Thus, in the example of FIG. 2, the WUR signal is aggregated with the other OFDM signals using one IFFT operation to produce an aggregated physical protocol data unit (A-PPDU). In an embodiment, at 207, a common guard interval (GI) may be inserted to the output of the IFFT block 206. The AP 205 may then transmit the A-PPDU that aggregates the WUR signals and non-WUR signals (e.g., the OFDM signals) to STA1 210 and STA2 220.

As further illustrated in the example of FIG. 2, STA1 210 may receive the A-PPDU from AP 205, may remove GI at 211, and may demodulate the OFDM signals using FFT block 212. STA2 220 may receive the A-PPDU from AP 205 and the WUR receiver of STA2 220 may use the LPF 221 to filter out noise (e.g., noise outside of the 4.5 MHz WUR bandwidth) before passing the filtered signals through an ELD 222 to detect WUR ON/OFF symbols. It should be noted that guard interval (GI) and cyclic prefix (CP) may be used interchangeably herein.

As will be discussed in more detail below, some embodiments provide a multicarrier on-off keying (MC-OOK) waveform generation design that completely aligns an on-off keying (OOK) ON/OFF symbol with the OFDM symbol and CP boundaries, which ensures there is no interference from WUR to OFDM signals. This can also simplify the waveform generation procedure, for example, as waveforms for both signals may be generated using the same hardware at the same time.

In some embodiments, the OOK signal waveform can carry two layers of information. One layer is in the time domain ON/OFF sequence that is intended for WUR receivers, and the other is in the subcarrier coefficients that may be intended for OFDM receivers.

Additionally, according to some embodiments, other MC-OOK waveform generation and encoding methods with higher data rate but waveforms quasi-orthogonal to OFDM signals are provided.

In some embodiments, the new MC-OOK waveform generation and encoding design capability can be exchanged between AP and STAs through the enhanced WUR capabilities element, the enhanced WUR operation element, and/or the enhanced WUR mode element, e.g., in Beacon frames, Probe Request/Response frames, (Re) Association Request/Response frames, and/or Action frames.

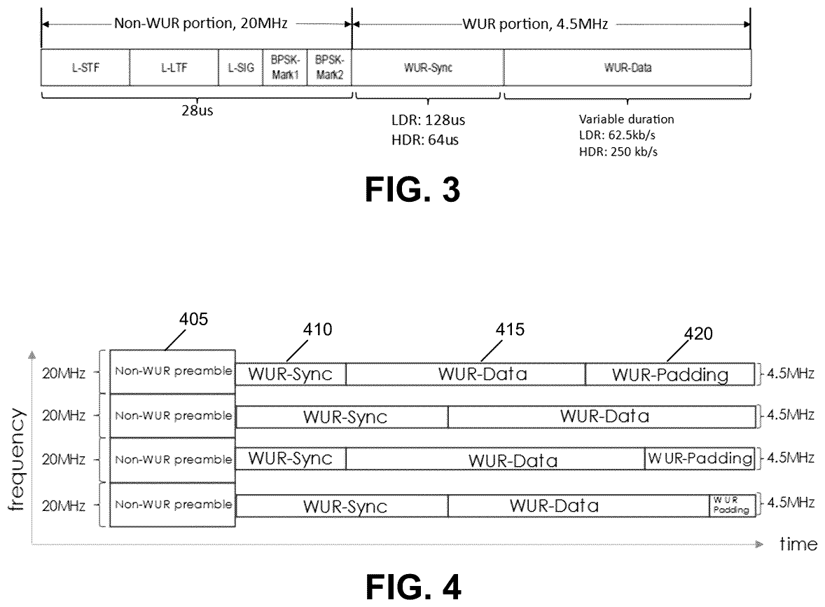

The basic 802.11ba physical layer protocol data unit (PPDU) has two portions, as shown in the example of FIG. 3. The two portions are a non-WUR portion and a WUR portion. The design of the non-WUR portion is most influenced by the requirement of coexisting with other 802.11 devices operating in the same frequency band. The non-WUR portion occupies 20 MHz and uses the standard OFDM waveform that can be decoded by non-WUR STAs, so that they recognize the duration of the WUR PPDU and defer to the current WUR transmission. The non-WUR portion, with a total duration of 28 us, includes legacy short training fields (L-STF), legacy long training fields (L-LTF), the legacy signal field (L-SIG), and two 802.11ba-defined fields BPSK-Mark1 and BPSK-Mark2. On the other hand, the WUR portion is mainly designed to meet the requirement of enabling the use of ultra-low-power noncoherent receivers. The WUR portion occupies a 4.5 MHz bandwidth and uses the on-off keying (OOK) modulation. The WUR portion includes the synchronization (WUR-Sync) field and the Data (WUR-Data) field. The WUR-Sync field serves three purposes for the WUR receivers: WUR PPDU detection, symbol timing recovery, and identification of the data rate used in the WUR-Data field. The WUR-Data field supports two data rates: the high data rate (HDR) of 250 kb/s and the low data rate (LDR) of 62.5 kb/s. The LDR support is mandatory while the HDR support is optional. If the WUR-Data field uses the HDR, the HDR WUR-Sync field includes 32 OOK symbols, each of a 2 us duration, with a total duration of 64 us; if the WUR-Data field uses the LDR, the LDR WUR-Sync field includes 64 OOK symbols with a total duration of 128 us. The HDR WUR-Data field uses a simple Manchester encoding scheme to map an information 0 bit to two encoded bits {1, 0} and an information 1 bit to {0, 1}. Each HDR encoded bit is an OOK symbol with a duration of 2 us. Similarly, the LDR WUR-Data field uses a combination of repetition and Manchester encoding to map an information 0 bit to four encoded bits {1, 0, 1, 0} and an information 1 bit to {0, 1, 0, 1}. Each LDR encoded bit is an OOK symbol with a duration of 4 us.

The generation of the OOK modulated signals used in the WUR-Sync and WUR-Data fields may be implementation dependent, e.g., without reference to specific methods mandated by the 802.11ba standards. However, the 802.11ba specification (e.g., See IEEE P802.11-REVme™/D5.0, Wireless LAN Medium Access Control (MAC) and Physical Layer (PHY) Specifications, February 2024 [3]) does suggest: “The WUR OOK modulation may be generated by using the multicarrier on-off keying (MC-OOK) modulation technique with a signal constructed from multiple subcarriers. When MC-OOK is used to generate the WUR OOK signal, MC-OOK should use 13 contiguous subcarriers, centered within a 20 MHz channel, with a subcarrier spacing of 312.5 kHz and the center subcarrier being null. The subcarrier coefficients may take values from the BPSK, QPSK, 16-QAM, 64-QAM, or 256-QAM constellations.” In addition, the 802.11ba specification provides example values for the subcarrier coefficients used for the construction of the 2 us and 4 us duration WUR OOK ON symbols using MC-OOK modulation. That is, the suggested MC-OOK is to generate a WUR OOK ON symbol in time domain by properly selecting an input sequence in frequency domain, based on the pre-802.11ax OFDM numerology design, i.e., 312.5 KHz subcarrier spacing over a 20 MHz channel and 1 NULL DC (direct current) subcarrier.

In addition to the 20 MHz WUR Basic PPDU format, the 802.11ba standards support the frequency domain multiple access (FDMA) of multiple WUR signals over 40 MHz and 80 MHz for higher efficiency and lower latency. An 80 MHz WUR FDMA PPDU example is shown in FIG. 4, according to some embodiments. In the example of FIG. 4, each WUR signal occupies a 20 MHz channel with the non-WUR preamble portion 405 filling the 20 MHz channel while the WUR Sync portion 410 plus WUR-Data portion 415 is in the middle 4.5 MHz of the 20 MHz channel. The non-WUR preamble portion 405 is duplicated every 20 MHz. A different WUR-Sync field 410 according to the rate of the WUR-Data field 415 may be applied to each 20 MHz subchannel and, to make the transmission duration on each 20 MHz channel the same, padding with OOK symbols (WUR-Padding 420) is added to the shorter duration signals. It is noted that over the 40 MHz or 80 MHz channels, some 20 MHz subchannels could be punctured, i.e., nothing is transmitted over the punctured channels. It is noted that the channel width illustrated in FIG. 4 is just one example, as other channel widths are also contemplated according to certain embodiments.

It is noted that Ultra High Reliability (UHR), or 802.11bn, is considered as the next major revision to IEEE 802.11 standards following 802.11be (High Efficiency Wireless, or HEW). UHR explores the possibility to improve reliability, support further reduced low latency traffic, further increase peak throughput, improve power saving capabilities, and improve efficiency of the IEEE 802.11 network over HEW.

It is further noted that the present disclosure may refer to data traffic that uses OFDM modulation signals as “UHR signals” or “OFDM signals” or “non-WUR signals”, but they can be OFDM signals for UHR or any future 802.11 standards. The same applies for “UHR PPDU” or “non-WUR PPDU”. Also, the WUR portion of the 802.11ba PPDU format may be referred to herein as “WUR signals” or “OOK signals” or “WUR PPDU” or “WUR frame”. In addition, it may be stated that the purpose of the WUR signals is to wake-up the MR of the WUR STA, but in some scenarios, the WUR signals may be the WUR portion of a WUR Beacon, Discovery, Wake-up, Short Wake-up, or Vendor Specific frame, for example.

To improve power saving capabilities, in addition to the non-HT, HT, VHT, or HE devices, it may be desirable to have WUR as a companion radio for EHT and UHR devices too. Such non-AP STAs with WUR receivers may be referred to herein as WUR STAs and APs with WUR transmitters as WUR APs.

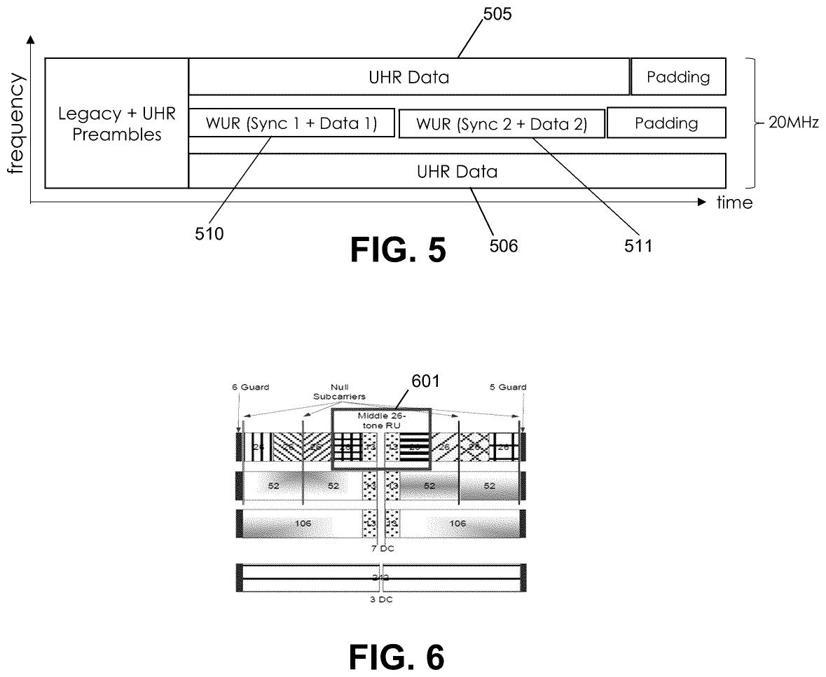

The current 802.11ba standards support the WUR FDMA PPDU format over 40 MHz and 80 MHz channels to send WUR signals only, albeit multiple of them, over different 20 MHz channels. However, in some scenarios, there may be simultaneously both low-latency traffic using OFDM signals to non-AP STAs and urgent need to wake up the MRs of WUR STAs in deep sleep mode using OOK signals. Such scenarios call for aggregation of OFDM signals with WUR signals in both the frequency and time domain for better efficiency and lower latency. The aggregation in the frequency domain may happen on the resource unit (RU) level within the same 20 MHz channel, as shown in FIG. 5 and FIG. 6.

FIG. 5 illustrates an example of aggregating a WUR PPDU with UHR PPDU, according to some embodiments. As shown in the example of FIG. 5, in this 20 MHz subchannel example, instead of dedicating the whole 20 MHz subchannel to a WUR signal while it effectively only occupies 4.5 MHz, the UHR data 505, 506 using the OFDM signal are also packed around the WUR signals 510, 511 to utilize the remaining spectrum. Additionally, in some examples, padding may be added to the UHR data and/or WUR signal(s).

FIG. 6 illustrates an example of a RU allocation in a 20 MHz subchannel aggregating WUR signals, e.g., which occupy the middle RUs shown in box 601, with UHR PPDU, e.g., which occupy the remaining RUs outside of box 601. In one 20 MHz example, as shown in the example of FIG. 6, the AP may allocate the three middle 26-tone RUs to WUR signals while allocating the remaining six 26-tone RUs to UHR signals; the three middle 26-tone RUs cover 4.5 MHz required by the WUR OOK signals plus guard bands to mitigate the WUR OOK signal leakage to the UHR OFDM signals. That is, if the 26-tone RUs are indexed from left to right as RU26-1, RU26-2, . . . , to RU26-9, RU26-4/5/6 are allocated to WUR signals and RU26-1/2/3 and RU26-7/8/9 may be allocated to UHR OFDM signals. In another example, the AP may allocate RU52-1 (combining RU26-1 and RU26-2), RU26-3, RU26-7, and RU52-4 (combining RU26-8 and RU26-9) to UHR signals. In yet another example, the AP may allocate RUs close to the edge of the subchannels, for example RU26-7/8/9 in a 20 MHz subchannel, to the WUR signals for better leakage management.

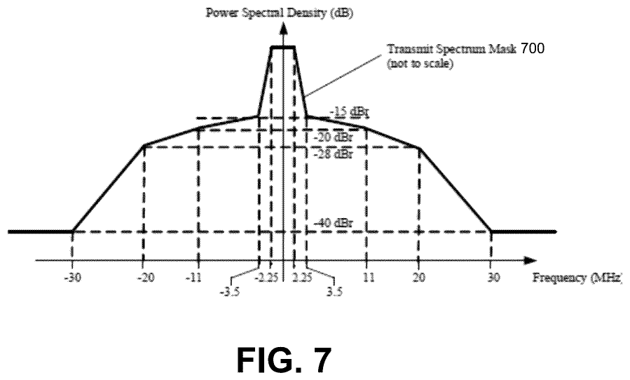

FIG. 7 illustrates a transmit spectrum mask of WUR signals as allowed by the standards. The transmit spectrum mask refers to the power contained in a specified frequency bandwidth at certain offsets, relative to the total carrier power. Given the transmit spectrum mask of the WUR signals allowed by the standards as shown in FIG. 7, if the middle two 26-tone RUs of a 20 MHz channel are allocated to WUR signals while the remaining RUs are occupied by the OFDM signals, then the OFDM signals may suffer interference from the WUR signals on the level of −10 dBr to −20 dBr (dB relative to the maximum spectral density of the signal) comparing to the peak WUR power level. A WUR signal waveform design with further reduced inter-RU interference or even completely orthogonal without interference to the OFDM signals is therefore desired.

Starting from the 802.11ax or HE amendment, one major physical layer (PHY) change is the increased DFT/IDFT period of the Data field, which is 12.8 us, four times of the legacy value of 3.2 us. Consequently, the subcarrier spacing is decreased from 312.5 kHz to 78.125 kHz, and the FFT size of a 20 MHz channel is increased from 64 to 256. With three options of the guard interval duration for the Data field, i.e., 0.8 us, 1.6 us, and 3.2 us, the OFDM symbol duration for 802.11ax/be/bn could be 13.6 us, 14.4 us, and 16 us. Apparently, the current 802.11ba WUR 2 us- and 4 us-long OOK symbols may not align with the newer OFDM symbols in term of cyclic prefix (CP) and symbol boundaries, and hence may not be orthogonal in the frequency domain to the OFDM signals and inevitably cause interference to the latter.

As mentioned above, the 802.11ba standards suggested the MC-OOK modulation, using multiple subcarriers within the 4.5 MHz WUR bandwidth to construct the baseband ON symbol as an OFDM symbol, or a portion of an OFDM symbol. However, it is based on the pre-11ax numerology using size-64 FFT in a 20 MHz channel. Since the UHR OFDM signals require a size-256 FFT in a 20 MHz channel, the transmitter may have to incur either extra hardware cost by using two FFT blocks to simultaneously generate the WUR and OFDM signals separately and then combine them together in the time domain, or extra timing delay by reusing one FFT block twice configured with different FFT sizes.

Thus, example embodiments described herein provide solutions for at least the problems noted above, as well as other problems that might not be explicitly discussed herein. For example, one solution according to some embodiments provides for the MC-OOK waveform generation using the same size-256 FFT by combining with the OFDM signals directly in the frequency domain, as discussed in more detail below.

It should be noted that, while some of the example figures discussed herein. provide an illustration of example A-PPDU(s) with WUR signals according to a 20 MHz bandwidth and its corresponding FFT sizes. The total bandwidth could be generalized to, for example, 40 MHz, 80 MHz, 160 MHz, 320 MHz, or any larger bandwidth that may be defined in future 802.11 standards. One UHR PPDU may span over different combinations of subchannels such as 20 MHz, 40 MHz, 40 MHz+20 MHz, 80 MHz, 80 MHz+20 MHz, 80 MHz+40 MHz, 80 MHz+80 MHZ, 160 MHz, 160 MHz+20 MHz, 160 MHz+40 MHz, 160 MHz+80 MHz, and so on. There may be any number of combinations and orderings of UHR PPDUs and WUR PDUs across the whole bandwidth as appropriate. The same applies to the FFT sizes.

According to some embodiments, a new MC-OOK design to generate WUR signals that are completely orthogonal to the UHR OFDM signals is provided. In some example embodiments, the MC-OOK symbol generation may use no more than 57 contiguous subcarriers, or tones, with a subcarrier spacing of 78.125 kHz for one OOK symbol. In this example, the number 57 comes from the transmit spectrum mask requirement for the WUR signals: the 0 dBr bandwidth is 4.5 MHz as shown in FIG. 7, and the maximum number of in-band subcarriers is given by the largest integer that is smaller than 4.5 MHz/78.125 kHz=57.6. However, it should be noted that, although the number 57 is used throughout this disclosure, example embodiments should not be limited to such a number of contiguous subcarriers. For example, if a future 802.11 amendment defines a new subcarrier spacing Δ_{f} for the OFDM signals, and the effective bandwidth of the WUR signals is changed to BW from 4.5 MHz, the required number of contiguous subcarriers would be given by [BW/Δ_{f}].

An OOK OFF symbol has all zero-value coefficients on the 57 WUR subcarriers, while an OOK ON symbol is generated by placing non-zero coefficients on at least one of the 57 subcarriers. In an OFDM transmitter, the frequency-domain subcarriers may be fed to an IFFT to convert to a time-domain waveform as the IFFT output with a duration of 12.8 us, which is the inverse of the subcarrier spacing 78.125 kHz. Depending on the selected guard interval duration of 0.8 or 1.6 or 3.2 us, which are currently defined for the HE/EHT/UHR OFDM signals, a copy of the tail end of the IFFT output is placed as cyclic prefix (CP), or interchangeably guard interval (GI), before the IFFT output to form an OFDM symbol of a total duration of 13.6, 14.4, or 16 us. That is, an OOK ON symbol would be such a non-zero amplitude OFDM symbol while an OOK OFF symbol is an all-zero amplitude symbol.

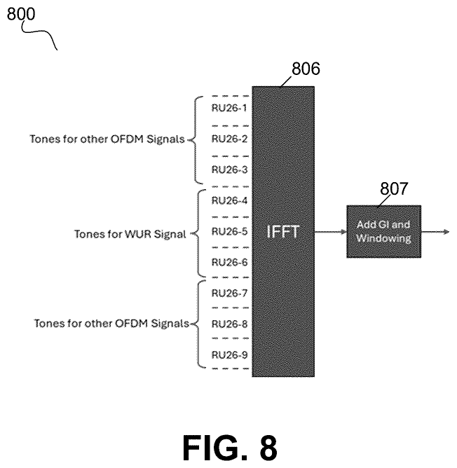

FIG. 8 illustrates an example of a transmitter or AP 800 that may aggregate a WUR signal with other OFDM signals using one IFFT operation 806 and common guard interval (GI) insertion 807 (e.g., in 20 MHz channel), according to some embodiments. An aggregated PPDU may assign other subcarriers, or resource units (RUs), within the bandwidth to UHR signals. An OFDM symbol would be generated by the OFDM transmitter with WUR coefficients on the contiguous WUR subcarriers (or contiguous subcarriers of one or more RUs for WUR signals) and OFDM coefficients on the other OFDM subcarriers (or other RUs for OFDMA signals). The WUR signals may use the same guard interval (GI) and OFDM symbol duration as the OFDM signals.

According to some embodiments, the waveform generation procedure, as illustrated in FIG. 8, has several benefits resulting from using the same numerology and waveform generation method for both the WUR and OFDM signals. For example, as a result of the procedure, a WUR OOK symbol is therefore perfectly aligned with a UHR OFDM symbol in both CP and symbol boundaries, and the WUR signals are completely orthogonal to other OFDM signals. This means that the WUR signals cause minimal or no interference to the other OFDM signals. Hence, it is feasible to achieve higher spectrum efficiency by aggregating the WUR and OFDM signals within a 20 MHz channel, both detectable or decodable at respective targeted receivers. This is an improvement over the current 802.11ba practice of allowing one WUR signal only per 20 MHz channel.

Additionally, based on the procedure, a single OFDM transmitter can multiplex both WUR and the rest of OFDM signals in the frequency domain using a single IFFT block with minimum hardware cost. This means that a non-AP STA can generate and transmit WUR signals to the AP without additional hardware cost. This in turn enables additional power saving use cases for APs. For example, a WUR AP can be equipped with a low-power WUR receiver as well. It can turn off its main radio to go to a sleep mode, only leaving the WUR receiver on to detect WUR signals. Only when the WUR receiver detects a wake-up signal, the AP turns on its MR to receive information.

Furthermore, based on the procedure, an OFDM receiver can recover the coefficients on all subcarriers and hence different coefficient sequences on the WUR subcarriers in MC-OOK ON symbols may be designed to carry additional information to the UHR OFDM users via a broadcasting or a unicasting manner. This means that the WUR MC-OOK waveform design provided herein, according to some embodiments, can use one waveform to carry two layers of information intended for possibly different users: one layer of information is carried through the time domain OOK ON/OFF patterns to the WUR receivers and another layer of additional information is carried through the frequency domain WUR subcarrier coefficients in the WUR ON symbols to the OFDM receivers. Some examples of such additional information to OFDM receivers may include: (a) for STAs in the same BSS, they can be used to indicate upcoming low latency traffic for the to-be-waken STA(s), including duration and/or bandwidth or any other parameters for upcoming traffic, which may trigger preemption operations for ongoing traffic or scheduled traffic; (b) for STAs in the same BSS or OBSS, they may be used to put some (inactive) STAs into sleep to save the power of those STAs or reduce (potential) interference and/or collision; (c) for STAs in OBSS, the coefficient sequences may carrier spatial reuse (SR) related parameters, such as enable/disable SR, per-subchannel PSR values; and/or (d) if the coefficient sequences are known at the UHR receivers, they can be used as additional pilot signals for better frequency or phase correction, or as additional training sequences for channel estimation or sensing.

It is noted that the coefficient sequence that can create the time-domain OOK ON symbol might not be unique, one may use different sequences for different ON symbols in time domain so that more indications can be created for different purposes.

From the receiver perspective, some receivers may be purely WUR receivers that will detect the time-domain WUR OOK ON/OFF patterns and decode the WUR information bits carried through the pattern; some receivers may be OFDM receivers that only monitor the MC-OOK subcarriers, decide if an OFDM symbol is an WUR OOK ON symbol, and decode from the information bits carried through the MC-OOK subcarriers in the OOK ON symbol; other receivers may be OFDM receivers that need to receive the information bits transmitted on the other RUs intended for UHR OFDM receivers and at the same time may or may not monitor and receive the information bits carried on the MC-OOK subcarriers of the WUR ON symbols; yet other receivers may first use a WUR receiver to decode the WUR information bits carried through the time-domain WUR OOK ON/OFF pattern, record the time domain samples of the OOK ON symbols, use the received WUR information bits to wake up an OFDM receiver, and use the OFDM receiver to decode the information bits carried through the MC-OOK subcarriers in the WUR OOK ON symbols.

With respect to the location of MC-OOK subcarriers, according to some embodiments, the contiguous MC-OOK subcarriers may be centered around any subcarrier within an aggregated PPDU bandwidth, e.g., 20 MHz, 40 MHz, 80 MHz, 160 MHz, or 320 MHz, as long as the transmit spectrum mask requirements for the PPDU are satisfied. However, with the introduction of the concept of resource unit (RU) in 802.11ax/be/bn and beyond, the location of the MC-OOK subcarrier block may be chosen such that the block spans over as fewer number of RUs as possible so that more RUs are left to be assigned to OFDM users. FIG. 8 shows an example in which the center three 26-tone RUs are used to construct a WUR signal in 20 MHz PPDU and the other RUs are used for transmitting OFDMA signals for other STAs. On the other hand, the low-cost non-coherent WUR receivers often use low-pass filters with lower complexity (hence lower power consumption) to filter out noise outside of the 4.5 MHz WUR bandwidth before passing the filtered signals through an envelope detector to detect WUR ON/OFF symbols. Such low-complexity filters suffer from a wider transition band as the filter changes from the pass band to the stop band. For this reason, it is desirable for the WUR MC-OOK subcarrier block to be placed as far away from RUs allocated to other signals as possible.

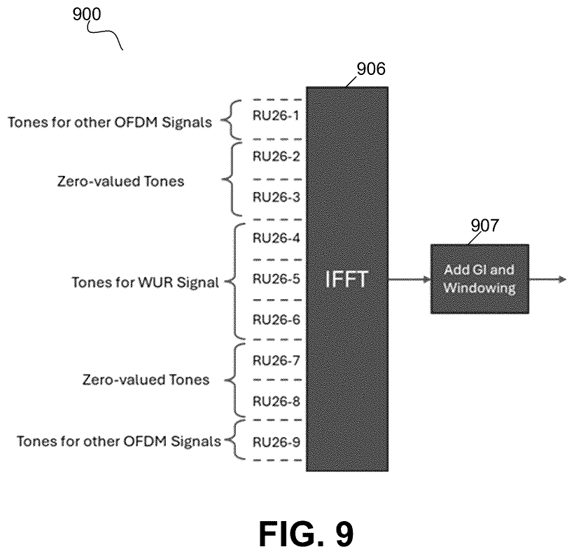

FIG. 9 illustrates an example of a transmitter or AP 900 that may aggregate a WUR signal with other OFDM signals and zero-valued RUs as guard band (e.g., in 20 MHz channel), according to some embodiments. In the example of FIG. 9, the WUR signal may be aggregated with the other OFDM signals and zero-valued tones using one IFFT operation 906 followed by common GI insertion 907. In one example of a 20 MHz PPDU, the middle three 26-tone RUs, i.e. RUs 4/5/6 as shown in FIG. 9, may be allocated to a WUR signal and the middle 57 subcarriers, −28 to 28, are used to generate the MC-OOK symbols with the middle 7 DC subcarriers having 0 as their coefficients. At the same time, RUs 1/9 can be allocated to one or more OFDM users. But RUs 2/3 and 7/8 may not be used in order to provide a transition guard band for the WUR low-pass filters. If the WUR low-pass filters require a narrower transition band, RUs 2/8 may also be allocated to OFDM users for higher spectrum efficiency.

According to some embodiments, the subcarrier coefficients for MC-OOK ON symbols may take values from the BPSK, QPSK, 16-QAM, 64-QAM, 256-QAM, 1024-QAM, 4096-QAM, or even higher-order constellations that may be defined in future 802.11 amendments. In one example, all MC-OOK subcarriers may be used with non-zero coefficients on them. In another example, a smaller number of subcarriers, e.g., 52 (four times the 13 subcarriers suggested in the current 802.11ba standards), may be used with non-zero values while the remaining subcarriers in the MC-OOK subcarrier set may have zero values. In a third example, the center subcarrier, or the center subcarrier plus a few subcarriers around it may have zero coefficients. In a fourth example, the subcarrier coefficients may be designed for different purposes such as to minimize the peak-to-average power ratio (PAPR), or out-of-band emission of the generated symbol. In yet another example, these WUR subcarrier coefficients on WUR ON symbols are determined by the additional information bits that the WUR transmitter wants to send to one or more UHR OFDM receivers as described previously. That is, the OOK WUR signals intended for WUR receivers are carried through the ON/OFF symbols, but in an ON symbol (e.g., in each ON symbol), the WUR subcarrier coefficients carry additional information intended for and recoverable by UHR OFDM receivers.

In some embodiments, the WUR-Sync field may include a fixed logic bit 0/1 sequence W to indicate the start of a WUR PPDU to WUR receivers. With the above mentioned OOK symbol generation method, an MC-OOK ON symbol can be mapped to logic bit 1 and OFF symbol (all zeros) to logic bit 0, or vice versa. In one example, the bit sequence could be the same as the 32-bit sequence W=[1,0,1,0,0,1,0,0,1,0,1,1,1,0,1,1,0,0,0,1,0,1,1,1,0,0,1,1,1,0,0,0] defined in the current 802.11ba amendment (e.g., See IEEE P802.11-REVme™/D5.0, Wireless LAN Medium Access Control (MAC) and Physical Layer (PHY) Specifications, February 2024 [3]), or its bitwise logical complement W. Depending on the OFDM CP size, one OOK symbol could be 13.6 us, 14.4 us, or 16 us long. With 32 symbols in the WUR-Sync field, it could be 435.2 us, 460.8 us, or 512 us long. Compared to the LDR WUR-Sync field in IEEE P802.11-REVme™/D5.0, this design has 3 to 4 times longer OOK symbols. But at a cost of lower data rate, it is much less susceptible to multipath inter-symbol interference, and it requires 5-6 dB less SNR for sequence detection. This enables the possibility of further lowering the cost and power consumption of WUR receivers.

If there are different data rates to be used in the later WUR-Data field, the data rate may be indicated in the WUR-Sync field. Different W sequences can be designed and mapped to different code rates. When a WUR receiver detects a specific sequence from the WUR-Sync field, it maps the sequence to a specific data rate and coding scheme used in the later WUR-Data field. For example, a sequence W₁ indicates a data rate of 1/16 us=62.5 kb/s, another sequence W₂ indicates a higher data rate of 125 kb/s, and a third sequence W₃ may indicate a lower data rate of 31.125 kb/s. One design criterion for W is to limit its runs of ones or zeros. Another design criterion is for different W sequences to have bigger Hamming distances among them and hence it is easier to distinguish them. In one example, all W sequences are of the same length. In another example, different W sequences may be of different lengths. Some W sequences may be concatenated to form a new W sequence. Some W sequences may be the logic complement of others.

According to some embodiments, the WUR-Data field may use the same OOK symbol generation method described above for logic bits 0 and 1. If there is no coding on the data bits, the coding rate is the inverse of the OOK symbol duration. For example, with a symbol duration of 16 us, the data rate is 62.5 kb/s, the same as the LDR in 802.11ba (e.g., See IEEE P802.11-REVme™/D5.0, Wireless LAN Medium Access Control (MAC) and Physical Layer (PHY) Specifications, February 2024 [3]). If an even lower data rate is desired, some coding scheme may be used to map an information bit to multiple encoded logic bits. For example, the same Manchester encoding schemes used in 802.11ba can be reused: information bit 1 encoded to {0, 1} and information bit 0 encoded to {1, 0} in the HDR scheme, or information bit 1 encoded to {0, 1, 0, 1} and information bit 0 encoded to {1, 0, 1, 0} in the LDR scheme.

The 802.11ba design has a symbol randomizer to eliminate spectral lines caused by the strong correlation between the ON symbols if the same MC-OOK ON symbol waveform is used for each ON symbol over time. The symbol randomizer uses the output of a linear feedback shift register (LFSR) to not only flip the polarity (+1) of the ON symbols, but also to apply a symbol-wise cyclic shift in timing delay. The first measure eliminates the spectral lines while the second measure further flattens the power spectrum density.

Some embodiments described herein may not need such a symbol randomizer when the WUR subcarrier coefficients on each ON symbol are used to carry additional information bits to UHR OFDM users. The information bits are random and so are the subcarrier coefficients. The ON symbols are then naturally not correlated to cause the spectral lines. Yet the same symbol randomizer can still be applied to some embodiments for power spectrum density management. Given now that the ON/OFF symbol duration is 16 us instead of 2 us or 4 us in 802.11ba, the values of pseudorandom cyclic shift recommended in 802.11ba could be adjusted in proportion to the increased symbol duration as shown in TABLE 1 below.

TABLE 1
Values of pseudorandom cyclic shift with cyclic shift index n for
the WUR-Sync field and WUR-Data field with 16 us OOK symbols

| n | 0 | 1 | 2 | 3 | 4 | 5 | 6 | 7 |
|---|---|---|---|---|---|---|---|---|
| Timing | 0 | −1600 | −3200 | −4800 | −6400 | −8000 | −9600 | −11200 |
| delay | | | | | | | | |
| (ns) | | | | | | | | |

Similarly, the per-transmit chain cyclic shift diversity (CSD) values recommended in 802.11ba could be adjusted in proportion to the increased symbol duration as shown in TABLE 2 below.

TABLE 2
Recommended CSD values for the WUR-Sync field
and WUR-Data field with 16 us OOK symbols

| | Number of | |
|---|---|---|
| Example | Transmit | |
| Sequence | Chains | CSD values (ns) |
| Example 1 | 1 | [0] |
| | 2 | [0, −4800] |
| | 3 | [0, −4800, −8800] |
| | 4 | [0, −4800, −8800, −10800] |
| | 5 | [0, −4800, −8800, −10800, −2800] |
| | 6 | [0, −4800, −8800, −10800, −2800, −6800] |
| | 7 | [0, −4800, −8800, −10800, −2800, −6800, −4800] |
| | 8 | [0, −4800, −8800, −10800, −2800, −6800, −4800, −10800] |
| Example 2 | 1 | [0] |
| | 2 | [0, −800] |
| | 3 | [0, −6800, −800] |
| | 4 | [0, −8800, −4800, −800] |
| | 5 | [0, −9600, −6800, −3600, −800] |
| | 6 | [0, −10400, −8000, −5600, −3200, −800] |
| | 7 | [0, −10800, −8800, −6800, −4800, −2800, −800] |
| | 8 | [0, −11200, −9200, −7600, −6000, −4400, −2400, −800] |
| Example 3 | 1 | [0] |
| | 2 | [0, −800] |
| | 3 | [0, −6800, −800] |
| | 4 | [0, −8800, −4800, −800] |
| | 5 | [0, −9800, −6800, −3800, −800] |
| | 6 | [0, −10400, −8000, −5600, −3200, −800] |
| | 7 | [0, −10800, −8800, −6800, −4800, −2800, −800] |
| | 8 | [0, −11000, −9400, −7600, −6000, −4200, −2600, −800] |

Since the MC-OOK design, as provided in some embodiments, has an ON/OFF symbol duration of 13.6 us, 14.4 us, or 16 us, when it is used alone to transmit a pure WUR PPDU in a 20 MHz channel, long sequences of OFF symbols may leave the medium unoccupied for a long time. If a non-WUR receiver detected and decoded the non-WUR preamble portion of a WUR PPDU, it would avoid transmission during the time indicated by the Length field. However, those STAs that did not properly get the Length field may simply listen to the medium and decide it is idle when they hear no signal on the medium for a long period of time. Collision happens when these STAs decide to transmit during the WUR PPDU. According to certain embodiments, this problem may be overcome by using dummy RUs that are in the same 20 MHz channel but not in the 4.5 MHz bandwidth occupied by the WUR signals. The WUR transmitter may occupy the medium during the OFF symbols through placing non-zero subcarrier coefficients in the dummy RUs. This way, non-WUR receivers would listen to the whole 20 MHz channel and deem the medium busy while the WUR receivers would not be affected since the dummy RUs would be filtered out as noise. Of course, such dummy RUs might not be necessary if an A-PPDU aggregates WUR signals with OFDM signals and assigns some RUs outside of the WUR bandwidth to OFDM signals.

The orthogonal MC-OOK design described above, according to some embodiments, has a data rate of 62.5 kb/s (if a symbol duration is 16 us) to 73.5 kb/s (if a symbol duration is 13.6 us), comparable to the LDR of 62.5 kb/s in the current 802.11ba standards. To achieve a higher data rate such as the HDR of 250 kb/s in the current 802.11ba standards, the duration of an OOK ON/OFF symbol may be decreased as shown in the several MC-OOK designs represented in the tables as discussed below. However, it should be noted that with ON/OFF masking within the duration of an OFDM symbol, the MC-OOK signals in general might not be orthogonal to the OFDM signals anymore.

In some embodiments, one approach is to place (e.g., only place) non-zero coefficients on every other one of the contiguous MC-OOK subcarriers. Using a 256-point IFFT, this will generate two identical copies of 128 IFFT samples (or a 6.4 us waveform). If the CP size of the OFDM symbols is 3.2 us, the last 32 samples of those 128 samples are prepended to the 128-sample copy to obtain 160 samples, or an 8 us waveform, as an MC-OOK ON symbol. Alternatively, if the CP size of the OFDM symbol is 0.8 us or 1.6 us, the last 8 or 16 samples of the 128 IFFT samples are prepended so that the MC-OOK ON symbol has a total duration of 6.8 us or 7.2 us respectively. Similarly, an MC-OOK OFF symbol is all zeros over the same duration as an ON symbol. This way, two MC-OOK symbols fit into the duration of one OFDM symbol. The WUR-Sync and WUR-Data fields are designed in a similar way as what is described in the previous section. Then the minimum data rate of this design is given by 1/8 us=125 kb/s, half of the HDR of 802.11ba.

In some embodiments, another approach is to use one non-zero coefficient in every 4 contiguous MC-OOK subcarriers. Using a 256-point IFFT, this will generate 4 identical copies of 64 IFFT samples (or a 3.2 us waveform). An ON symbol of 3.2 us long would comprise one such copy, and an OFF symbol is an all-zero-amplitude symbol of the same duration. Then, 5 such 3.2 us-long MC-OOK ON/OFF symbols, say [s₁, s₂, s₃, s₄, s₅], would fit into a 16 us-long OFDM symbol. One option is to always have s₁=s₅ so that s₁ serves as the CP in the OFDM symbol. This way, an OFDM receiver may remove the CP and recover the additional information on the subcarriers that are used to generate [s₂, s₃, s₄, s₅]. On the other hand, the ON/OFF status of [s₂, s₃, s₄, s₅] may carrier 4-bit information to a WUR OOK receiver. This would provide a data rate of 250 kb/s, the same as the HDR of 802.11ba. In another example, an OOK encoding scheme can be applied to [s₂, s₃, s₄, s₅] to carry 2 information bits. One such scheme is using the Manchester encoding scheme to map information bit 0 to logic bits [1 0] or [ON OFF], and to map information bit 1 to logic bits [0 1] or [OFF ON], as shown in TABLE 3 below. This example has a data rate of 2/16 us=125 kb/s, half of the HDR of 802.11ba.

TABLE 3
Example of carrying 2 information bits through [s₁ =
s₅, s₂, s₃, s₄, s₅] patterns in a 16 us-long OFDM symbol
where each of sᵢ, i = 1, 2, 3, 4, 5, is a 3.2 us-
long ON or OFF symbol for logic bit 1 or 0

| Information bits | 00 | 01 | 10 | 11 |
|---|---|---|---|---|
| [s₁ = s₅, s₂, s₃, s₄, s₅] | [0 1 0 1 0] | [1 1 0 0 1] | [0 0 1 1 0] | [1 0 1 0 1] |

According to some embodiments, to enable the concurrent transmission of WUR signal(s) and other non-WUR 802.11 signals in an OFDMA or A-PPDU format, parameter exchange and setup about the WUR capabilities of the AP and STAs may be performed beforehand. For example, such parameter exchange may be performed through the enhanced WUR capabilities element, the enhanced WUR operation element, and/or the enhanced WUR mode element in Beacom frames, Probe Request/Response frames, (Re) Association Request/Response frames, and/or Action frames.

In some embodiments, with newer MC-OOK waveform generation/encoding methods provided herein, the existing WUR Capabilities element may be modified to indicate which methods are supported by the WUR AP and STAs. For example, the WUR Capabilities element as shown in TABLE 4 may have the same format as defined in IEEE P802.11-REVme™/D5.0 [3], but its WUR Capabilities Information subfield may be modified to include an Additional WUR OFDMA mode subfield, as shown in TABLE 5 below which specifies the newer methods that the WUR STA/AP may support. In one example, this field may be 1-bit, with 1 for supporting newer methods and 0 for not supporting newer methods. In another example, this field may have multiple bits indicating the support of one or more of the example MC-OOK waveform generation/encoding methods listed in TABLE 6 below.

The selection of the MC-OOK waveform generation/encoding methods for WUR operation may be signalled in the WUR operation element or the WUR mode element between STAs. In one example, a new subfield may be added to the existing WUR Operation Parameters field in the WUR operation element (e.g., as defined in IEEE P802.11-REVme™/D5.0 [3]) to indicate which method is selected. In another example, the WUR Parameters Control or WUR Parameters fields in the existing WUR mode element (e.g., as defined in IEEE P802.11-REVme™/D5.0 [3]) may be modified to have a new subfield to indicate the selection of the newer MC-OOK waveform generation/encoding methods.

TABLE 4
WUR Capabilities Element

| | | | | |
|---|---|---|---|---|
| Element | Length | Element | Supported | WUR |
| ID | | ID | Bands | Capabilities |
| | | Extension | | Information |

TABLE 5
Modified WUR Capabilities Information Field Format

| | | | | | | | |
|---|---|---|---|---|---|---|---|
| | | | 20 MHz | | | | |
| | | | WUR | | WUR | | |
| | | | Basic | | Short | | |
| | VL | WUR | PPDU | | Wake- | Additional | |
| | WUR | Group | with | WUR | up | WUR | |
| Transition | Frame | IDs | HDR | FDMA | Frame | OFDMA | |
| Delay | Support | Support | Support | Support | Support | mode | Reserved |

TABLE 6
WUR MC-OOK waveform generation and encoding method

| WUR MC-OOK | |
|---|---|
| waveform generation | |
| and encoding | |
| method index | Description |
| 0 | Existing 802.11ba support |
| 1 | MC-OOK symbols having the same symbol |
| | and CP durations as OFDM symbols; OFDM |
| | CP size 0.8/1.6/3.2 us; orthogonal to each |
| | other; WUR data rate ≥62.5 kb/s |
| 2 | One MC-OOK symbol having half of the |
| | OFDM symbol duration; OFDM CP size |
| | 0.8/1.6/3.2 us; WUR data rate ≥125 kb/s |
| 3 | One MC-OOK symbol having one fifth of the |
| | OFDM symbol duration (16 us); OFDM CP |
| | size 3.2 us; five OOK-symbol group [s₁ = |
| | s₅, s₂, s₃, s₄, s₅] carry 4-bit information; WUR |
| | data rate 250 kb/s |
| 4 | One MC-OOK symbol having one fifth of the |
| | OFDM symbol duration (16 us); OFDM CP |
| | size 3.2 us; five OOK-symbol group [s₁ = |
| | s₅, s₂, s₃, s₄, s₅] carry 2-bit information with |
| | Manchester coding; WUR data rate 125 kb/s |

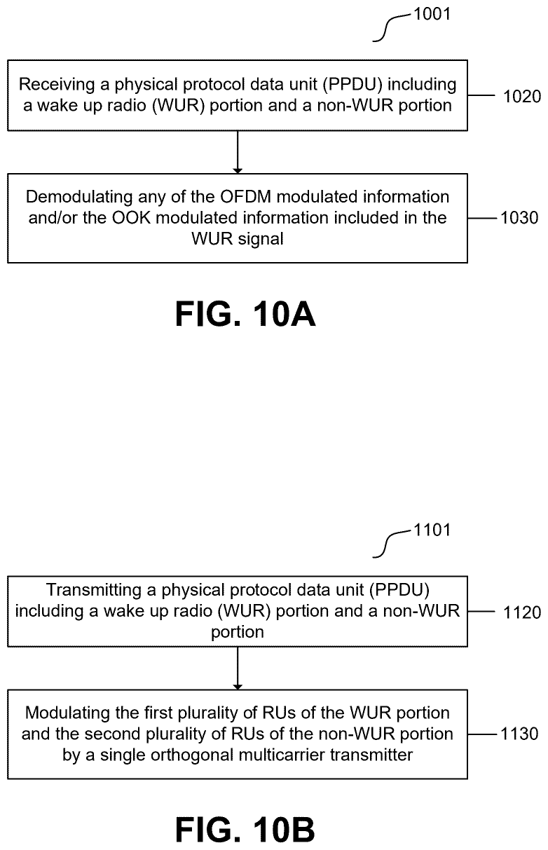

FIG. 10A is an example flow diagram illustrating an example method 1001 relating to waveform generation for WUR signals, according to an embodiment. The example method of FIG. 10A and accompanying disclosures herein may be considered an application, generalization and/or synthetization of the various disclosures discussed above. For convenience and simplicity of exposition, the example of FIG. 10A may be described with reference to the architecture or system described above with respect to FIGS. 1A-1D and/or FIG. 2, for instance. However, the example method depicted in FIG. 10A may be carried out using different architectures as well. According to some embodiments, the method of FIG. 10A may be implemented by a STA, such as one or more of the STAs 210, 212 described in reference to FIG. 2. Further, the method of FIG. 10A may be modified to include any of the steps, procedures, portions of procedures and/or details illustrated in the other flow diagrams described herein. Moreover, it is noted that the method and/or blocks of FIG. 10A may be modified to include, or to be replaced by, any one or more of the procedures or blocks discussed elsewhere herein. As such, one of ordinary skill in the art would understand that FIG. 10A is provided as one example and modifications thereto are possible while remaining within the scope of certain example embodiments.

As illustrated in the example of FIG. 10A, the method 1001 may include, at 1020, receiving, e.g., from an access point (AP) or other device, a physical protocol data unit (PPDU) including a wake up radio (WUR) portion and a non-WUR portion. The WUR portion may include a WUR signal occupying a first plurality of resource units (RUs). The WUR signal may include orthogonal frequency division multiplexing (OFDM) modulated information and on-off-keying (OOK) modulated information. The non-WUR portion may include OFDM signals occupying a second plurality of resource units (RUs). In an embodiment, the WUR signal uses a same guard interval and OFDM symbol duration as the OFDM signals. In an embodiment, the WUR signal and OFDM signals are orthogonal to each other in the frequency domain.

In some embodiments, the method 1001 may further include, at 1030, demodulating any of the OFDM modulated information and/or the OOK modulated information included in the WUR signal. According to an embodiment, the demodulating 1030 may include demodulating any one or more of the OFDM modulated information of the WUR signal and/or the OFDM signals by a single orthogonal multicarrier receiver. For example, the single orthogonal multicarrier receiver may include a single fast Fourier transform (FFT) block.

According to some embodiments, the method 1001 may include demodulating the OOK modulated information by a non-coherent receiver from OOK symbol sequences, where an OOK OFF symbol includes an all-zero amplitude symbol and/or an OOK ON symbol includes a non-zero amplitude symbol. In some embodiments, the ON symbol including a non-zero amplitude symbol includes different coefficient sequences on subcarriers of one or more of the first plurality of RUs. The different coefficient sequences may include OFDM modulated information indicating any of upcoming traffic information, power saving information, spatial reuse information, and/or additional pilot information. For example, the upcoming traffic information may include information corresponding to low latency traffic.

It is noted that the flow diagram illustrated in FIG. 10A is provided as one example, and modifications thereto are contemplated according to certain embodiments as discussed elsewhere herein. For example, one or more of the steps illustrated in FIG. 10A may be omitted, combined, modified and/or performed in a different order, as provided in the example embodiments discussed herein.

FIG. 10B is an example flow diagram illustrating an example method 1101 relating to waveform generation for WUR signals, according to an embodiment. The example method of FIG. 10B and accompanying disclosures herein may be considered an application, generalization and/or synthetization of the various disclosures discussed above. For convenience and simplicity of exposition, the example of FIG. 10B may be described with reference to the architecture or system described above with respect to FIGS. 1A-1D and/or FIG. 2, for instance. However, the example method depicted in FIG. 10B may be carried out using different architectures as well. According to some embodiments, the method of FIG. 10B may be implemented by an AP, such as AP 205 described in reference to FIG. 2. Further, the method of FIG. 10B may be modified to include any of the steps, procedures, portions of procedures and/or details illustrated in the other flow diagrams described herein. Moreover, it is noted that the method and/or blocks of FIG. 10B may be modified to include, or to be replaced by, any one or more of the procedures or blocks discussed elsewhere herein. As such, one of ordinary skill in the art would understand that FIG. 10B is provided as one example and modifications thereto are possible while remaining within the scope of certain example embodiments.

As illustrated in the example of FIG. 10B, the method 1101 may include, at 1120, transmitting, to a station (STA), a physical protocol data unit (PPDU) including a wake up radio (WUR) portion and a non-WUR portion. The WUR portion may include a WUR signal occupying a first plurality of resource units (RUs), and the non-WUR portion may include orthogonal frequency division multiplexing (OFDM) signals occupying a second plurality of resource units (RUS). In an embodiment, the WUR signal may use the same guard interval and OFDM symbol duration as the OFDM signals. In an embodiment the WUR signal and OFDM signals are orthogonal to each other.

According to some embodiments, the method 1101 may include, at 1130, modulating the first plurality of RUs of the WUR portion and the second plurality of RUs of the non-WUR portion by a single orthogonal multicarrier transmitter. In an embodiment, the modulated first plurality of RUs include OFDM modulated information and on-off-keying (OOK) modulated information. In some embodiments, the single orthogonal multicarrier transmitter may include a single inverse fast Fourier transform (IFFT) block.

According to some embodiments, the OOK modulated information is transmitted over OOK symbol sequences, where an OOK OFF symbol includes an all-zero amplitude symbol and/or an OOK ON symbol includes a non-zero amplitude symbol.

In some embodiments, the ON symbol including a non-zero amplitude symbol may include different coefficient sequences on subcarriers of one or more of the first plurality of Rus. The different coefficient sequences may include OFDM modulated information indicating any of upcoming traffic information, power saving information, spatial reuse information, and/or additional pilot information. For example, the upcoming traffic information may include information corresponding to low latency traffic.

It is noted that the flow diagram illustrated in FIG. 10B is provided as one example, and modifications thereto are contemplated according to certain embodiments as discussed elsewhere herein. For example, one or more of the steps illustrated in FIG. 10B may be omitted, combined, modified and/or performed in a different order, as provided in the example embodiments discussed herein.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety.
[1] IEEE Std 802.11™-2020: Wireless LAN Medium Access Control (MAC) and Physical Layer (PHY) Specifications;
[2] IEEE P802.11ax™/D8.0: Wireless LAN Medium Access Control (MAC) and Physical Layer (PHY) Specifications;
[3] IEEE P802.11-REVme™/D5.0: Wireless LAN Medium Access Control (MAC) and Physical Layer (PHY) Specifications, February 2024;
[4] IEEE 802.11-16/1045r9, “A PAR Proposal for Wake-up Radio,” July 2016.

What is claimed is:

1. A station (STA), comprising:
a transceiver; and
a processor coupled to the transceiver,
wherein the transceiver and processor are configured to:
receive, from an access point (AP), a physical protocol data unit (PPDU) comprising a wake up radio (WUR) portion and a non-WUR portion, the WUR portion comprising a WUR signal occupying a first plurality of resource units (RUs), wherein the WUR signal includes orthogonal frequency division multiplexing (OFDM) modulated information and on-off-keying (OOK) modulated information, and the non-WUR portion comprising OFDM signals occupying a second plurality of resource units (RUs), wherein the WUR signal uses a same guard interval and OFDM symbol duration as the OFDM signals, the WUR signal and OFDM signals being orthogonal to each other in a frequency domain; and
demodulate one of the OFDM modulated information or the OOK modulated information included in the WUR signal.

2. The STA of claim 1, further comprising a single orthogonal multicarrier receiver, wherein any of (1) the OFDM modulated information of the WUR signal and (2) the OFDM signals are demodulated by the single orthogonal multicarrier receiver.

3. The STA of claim 2, wherein the single orthogonal multicarrier receiver comprises a single fast Fourier transform (FFT) block.

4. The STA of claim 1, further comprising a non-coherent receiver, wherein the OOK modulated information are demodulated by the non-coherent receiver from OOK symbol sequences, wherein:
an OOK OFF symbol includes an all-zero amplitude symbol; and
an OOK ON symbol includes a non-zero amplitude symbol.

5. The STA of claim 4, wherein the ON symbol including a non-zero amplitude symbol comprises different coefficient sequences on subcarriers of one or more of the first plurality of RUs, the different coefficient sequences including OFDM modulated information indicating any of upcoming traffic information, power saving information, spatial reuse information, and additional pilot information.

6. The STA of claim 5, wherein the upcoming traffic information comprises information corresponding to low latency traffic.

7. A method, comprising:
receiving, from an access point (AP), a physical protocol data unit (PPDU) comprising a wake up radio (WUR) portion and a non-WUR portion, the WUR portion comprising a WUR signal occupying a first plurality of resource units (RUs), wherein the WUR signal includes orthogonal frequency division multiplexing (OFDM) modulated information and on-off-keying (OOK) modulated information, and the non-WUR portion comprising OFDM signals occupying a second plurality of resource units (RUs), wherein the WUR signal uses a same guard interval and OFDM symbol duration as the OFDM signals, the WUR signal and OFDM signals being orthogonal to each other in a frequency domain; and
demodulating one of the OFDM modulated information or the OOK modulated information included in the WUR signal.

8. The method of claim 7, further comprising demodulating any of (1) the OFDM modulated information of the WUR signal and (2) the OFDM signals by a single orthogonal multicarrier receiver.

9. The method of claim 8, wherein the single orthogonal multicarrier receiver comprises a single fast Fourier transform (FFT) block.

10. The method of claim 7, further comprising demodulating the OOK modulated information by a non-coherent receiver from OOK symbol sequences, wherein:
an OOK OFF symbol includes an all-zero amplitude symbol; and
an OOK ON symbol includes a non-zero amplitude symbol.

11. The method of claim 10, wherein the ON symbol including a non-zero amplitude symbol comprises different coefficient sequences on subcarriers of one or more of the first plurality of RUs, the different coefficient sequences including OFDM modulated information indicating any of upcoming traffic information, power saving information, spatial reuse information, and additional pilot information.

12. The method of claim 11, wherein the upcoming traffic information comprises information corresponding to low latency traffic.

13. An access point (AP), comprising:
a transceiver; and
a processor coupled to the transceiver,
wherein the transceiver and processor are configured to:
transmit, to a station (STA), a physical protocol data unit (PPDU) comprising a wake up radio (WUR) portion and a non-WUR portion, the WUR portion comprising a WUR signal occupying a first plurality of resource units (RUs), and the non-WUR portion comprising orthogonal frequency division multiplexing (OFDM) signals occupying a second plurality of resource units (RUs), wherein the WUR signal uses a same guard interval and OFDM symbol duration as the OFDM signals, the WUR signal and OFDM signals being orthogonal to each other; and
modulate the first plurality of RUs of the WUR portion and the second plurality of RUs of the non-WUR portion by a single orthogonal multicarrier transmitter, wherein the modulated first plurality of RUs include OFDM modulated information and on-off-keying (OOK) modulated information.

14. The AP of claim 13, wherein the single orthogonal multicarrier transmitter comprises a single inverse fast Fourier transform (IFFT) block.

15. The AP of claim 13, wherein the OOK modulated information is transmitted over OOK symbol sequences, wherein:
an OOK OFF symbol includes an all-zero amplitude symbol; and
an OOK ON symbol includes a non-zero amplitude symbol.

16. The AP of claim 15, wherein the ON symbol including a non-zero amplitude symbol comprises different coefficient sequences on subcarriers of one or more of the first plurality of RUs, the different coefficient sequences including OFDM modulated information indicating any of upcoming traffic information, power saving information, spatial reuse information, and additional pilot information.

17. The AP of claim 16, wherein the upcoming traffic information comprises information corresponding to low latency traffic.

18. A method, comprising:
transmitting, to a station (STA), a physical protocol data unit (PPDU) comprising a wake up radio (WUR) portion and a non-WUR portion, the WUR portion comprising a WUR signal occupying a first plurality of resource units (RUS), and the non-WUR portion comprising orthogonal frequency division multiplexing (OFDM) signals occupying a second plurality of resource units (RUs), wherein the WUR signal uses a same guard interval and OFDM symbol duration as the OFDM signals, the WUR signal and OFDM signals being orthogonal to each other; and
modulating the first plurality of RUs of the WUR portion and the second plurality of RUs of the non-WUR portion by a single orthogonal multicarrier transmitter, wherein the modulated first plurality of RUs include OFDM modulated information and on-off-keying (OOK) modulated information.

19. The method of claim 18, wherein the single orthogonal multicarrier transmitter comprises a single inverse fast Fourier transform (IFFT) block.

20. The method of claim 18, wherein the OOK modulated information is transmitted over OOK symbol sequences, wherein:
an OOK OFF symbol includes an all-zero amplitude symbol; and
an OOK ON symbol includes a non-zero amplitude symbol.
